(19) United States
(12) Patent Application Publication
(10) Pub. No.: US 2021/0285659 A1
(43) Pub. Date: Sep. 16, 2021

(54) Descaling Device for Water Heater

(71) Applicant: Tingfu Qin, Anyang (CN)

(72) Inventor: Tingfu Qin, Anyang (CN)

(21) Appl. No.: 16/817,635

(22) Filed: Mar. 13, 2020

(51) Int. Cl. F24D 19/00; F24H 9/00

(52) U.S. Cl. CPC F24D 19/0092; F24H 9/0042

(57) ABSTRACT

The invention disclosures a descaling device for water heater, comprising water heater tank, descaling box, feed pipe, discharge pipe, discharge box, water inlet, water outlet and decompression valve in water heater body, the descaling box is provided on upper portion of the water heater tank, and connected to the water heater tank through feed pipe, the discharge pipe is provided on lower portion of the water heater tank, the water heater tank is connected to the discharge box through discharge pipe, the invention is simple and is convenient to use, the disincrustant enters the water heater tank through feed pipe, and reacts with the water scale therein under the action of vibrator and the hot water, the sewage is removed is collected from the discharge pipe into the discharge box, and the discharge pipe can also be directly connected to the sewer line to facilitate the discharge of sewage.

### BACKGROUND OF THE INVENTION

### 1. Technical Field

The invention relates to the household goods technology field, in particular to a descaling device for water heater.

With the improvement of living standards, water heaters have become one of the necessary home appliances. However, while the water heater brings convenience to people, it also brings problems such as water scale. Because water contains calcium, magnesium and other ions, calcium and magnesium ions combine with acid ions in the water to form insoluble substances when heated, and stick to heating surface and heat exchange surface to form water scale, which affects the heat transfer efficiency and blocks the pipeline, the thermal conductivity of the water scale is very poor, and when a large amount of water scale is attached to the heating rod, the heating efficiency will be seriously affected. The presence of water scale will cause the heating rod to overheat while increasing the power consumption, which will reduce the service life of the water heater and even endanger the personal safety of users, as for general water heaters do not have a descaling device, and it is very inconvenient for users to ask a professional for descaling when needed; also, if the water scale not treated for a long time, which will not only affect the heating effect of the electric water heater, but also block the pipeline and affect the use.

### SUMMARY OF THE INVENTION

In order to solve above technical problem, the invention provides a technical scheme: a descaling device for water heater, comprising water heater tank, descaling box for storing disincrustant, feed pipe, discharge pipe, discharge box, water inlet, water outlet and decompression valve in water heater body, the descaling box is provided on upper portion of the water heater tank, the descaling box is connected to the water heater tank through feed pipe, the discharge pipe is provided on lower portion of the water heater tank, the water heater tank is connected to the discharge box through the discharge pipe, the water inlet, water outlet and decompression valve are provided on lower portion of the water heater tank away from the discharge pipe, and are connected to inside of the water heater tank.

As the further improvement, water inlet control valve is provided on the water inlet.

As the further improvement, water outlet control valve is provided on the water outlet.

As the further improvement, discharge control valve is provided on the discharge pipe.

As the further improvement, feed control valve is provided on the feed pipe.

As the further improvement, lower portion of the descaling box is a tapered bottom protruding towards the feed pipe, and disincrustant adding hole is provided on upper portion of the descaling box.

As the further improvement, overflow pipe is provided on top of the discharge box.

As the further improvement, sealing rings are respectively provided at the joints of the feed pipe, the discharge pipe, water inlet, water outlet and water heater tank, a vibrator is also provided on the outer wall of the bottom of the water heater tank.

By adapting above structure, the invention has following advantageous effects: the invention has a simple structure and is convenient to use, the disincrustant enters the water heater tank through the feed pipe, and reacts with the water scale inside the water heater tank under the action of the vibrator and the hot water in the water heater tank, the sewage after the water scale is removed is collected from the discharge pipe into the discharge box, and the discharge pipe can also be directly connected to the sewer line to facilitate the discharge of sewage.

### BRIEF DESCRIPTION OF ACCOMPANYING DRAWINGS

FIG. 1 shows the structure of a descaling device for water heater.

In the accompanying drawings: 1 refers to water heater tank, 2 refers to descaling box, 3 refers to feed pipe, 4 refers to discharge pipe, 5 refers to discharge box, 6 refers to water inlet, 7 refers to water outlet, 8 refers to decompression valve, 9 refers to water inlet control valve, 10 refers to water outlet control valve, 11 refers to discharge control valve, 12 refers to feed control valve, 13 refers to overflow pipe.

### BRIEF DESCRIPTION OF THE PREFERRED EMBODIMENTS

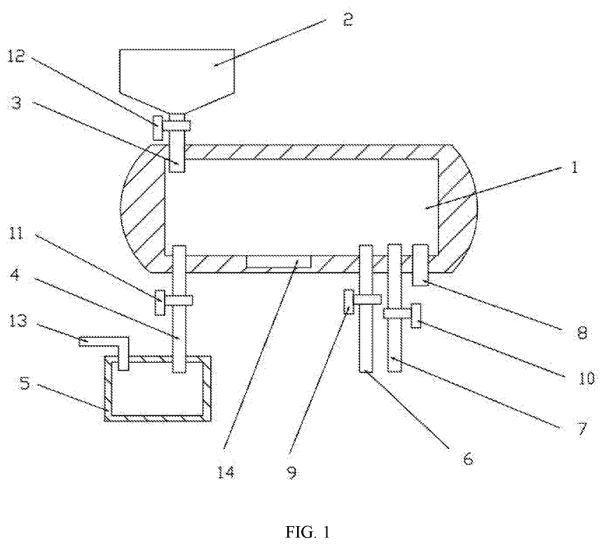

As shown in FIG. 1, a descaling device for water heater, comprising water heater tank 1, descaling box 2 for storing disincrustant, feed pipe 3, discharge pipe 4, discharge box 5, water inlet 6, water outlet 7 and decompression valve 8 in water heater body, the descaling box 2 is provided on upper portion of the water heater tank 1, the descaling box 2 is connected to the water heater tank 1 through feed pipe 6, the discharge pipe 4 is provided on lower portion of the water heater tank 1, the water heater tank 1 is connected to the discharge box 5 through the discharge pipe 4, the water inlet 6, water outlet 7 and decompression valve 8 are provided on lower portion of the water heater tank 1 away from the discharge pipe 1, and are connected to inside of the water heater tank 1.

As a preferred embodiment, water inlet control valve 9 is provided on the water inlet 6.

As a preferred embodiment, water outlet control valve 10 is provided on the water outlet 7.

As a preferred embodiment, discharge control valve 11 is provided on the discharge pipe 4.

As a preferred embodiment, feed control valve 12 is provided on the feed pipe 3.

As a preferred embodiment, lower portion of the descaling box 2 is a tapered bottom protruding towards the feed pipe 12, and disincrustant adding hole is provided on upper portion of the descaling box 2.

As a preferred embodiment, overflow pipe 13 is provided on top of the discharge box 5.

As a preferred embodiment, sealing rings are respectively provided at the joints of the feed pipe 3, the discharge pipe 4, water inlet 6, water outlet 7 and water heater tank 1, a vibrator 14 is also provided on the outer wall of the bottom of the water heater tank 1.

In specific embodiment of the invention, turning on the water inlet 6 to flood the water into the water heater tank 1 along the water pipe, and opening the feed control valve 12 to make the disincrustant in the descaling box 2 enter inside the water heater tank from the feed pipe 3, turning on the heating switch of the water heater causes the water heater to heat the water in the water heater tank 1, thereby the disincrustant reacts with the water scale, after waiting for a period of time, the discharge control valve 11 is opened to discharge the waste water, and after tow or three removal, the water scale can be cleaned.

Both electric water heaters and solar water heaters have water heater tanks. The invention can be used in the upper portion of electric water heaters and solar water heaters, by arranging feed pipe 3, discharge pipe 4, water inlet 6, water outlet 7 and decompression valve 8 on the tank of electric water heater or that of the solar water heater, the effect of removing water scale can be achieved, simultaneously, the principle of the invention can be adopted on gas water heater, by arranging feed pipe 3, discharge pipe 4, water inlet 6, water outlet 7 and decompression valve 8 on the gas water heater, and the effect of removing scale is achieved through the water circulation of the circulating water pipe of the gas water heater, and the effect of removing water scale is achieved through the water circulation of the circulating pipe of the gas water heater, wherein the principle remains the same.

The invention and the embodiment thereof has been described above, the description is not restrictive, only one embodiment of the invention is shown in the accompanying drawings, and the actual structure is not limited thereto. In conclusion, the similar structures and embodiments with the technical scheme of the invention, which are designed by the general skilled person in the art inspired by the invention, without creativity and without departing from the spirit of the invention, should be included in the protection scope of the invention.

1. A descaling device for water heater, comprising water heater tank, descaling box for storing disincrustant, feed pipe, discharge pipe, discharge box, water inlet, water outlet and decompression valve in water heater body, the descaling box is provided on upper portion of the water heater tank, the descaling box is connected to the water heater tank through feed pipe, the discharge pipe is provided on lower portion of the water heater tank, the water heater tank is connected to the discharge box through the discharge pipe, the water inlet, water outlet and decompression valve are provided on lower portion of the water heater tank away from the discharge pipe, and are connected to inside of the water heater tank.

2. The descaling device for water heater of claim 1, wherein water inlet control valve is provided on the water inlet.

3. The descaling device for water heater of claim 1, wherein water outlet control valve is provided on the water outlet.

4. The descaling device for water heater of claim 1, wherein discharge control valve is provided on the discharge pipe.

5. The descaling device for water heater of claim 1, wherein feed control valve is provided on the feed pipe.

6. The descaling device for water heater of claim 1, wherein lower portion of the descaling box is a tapered bottom protruding towards the feed pipe, and disincrustant adding hole is provided on upper portion of the descaling box.

7. The descaling device for water heater of claim 1, wherein overflow pipe is provided on top of the discharge box.

8. The descaling device for water heater of claim 1, wherein sealing rings are respectively provided at the joints of the feed pipe, the discharge pipe, water inlet, water outlet and water heater tank, a vibrator is also provided on the outer wall of the bottom of the water heater tank.
